(19) United States
(12) Patent Application Publication
(10) Pub. No.: US 2006/0141182 A1
(43) Pub. Date: Jun. 29, 2006

(54) Shrink label container with post applied handle

(75) Inventor: Edward John Giblin, Hopatcong, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 11/025,292

(22) Filed: Dec. 29, 2004

(51) Int. Cl. F16B 4/00

(52) U.S. Cl. 428/34.9

(57) ABSTRACT

The present invention is directed to a container that is shrink labelled and has a handle that is applied to the container after the container has been shrink labelled.

### FIELD OF THE INVENTION

The present invention is directed to a shrink labelled container. More particularly, the invention is directed to a shrink labelled container having a handle that is applied to the container after the container has been shrink labelled.

### BACKGROUND OF THE INVENTION

Containers are used in many industries, including the consumer goods industry, for packaging many types of products which come in various forms, including liquids. Traditionally, labels which are adhered onto the containers have been used to provide decoration and convey other information to the user such as promotional/advertising indicia, contents of the ingredients and product use instructions. However, conventional labelling technology such as wet glue labels, self-adhesive labels, or in mold labels only allow the use of limited surface area of the container for decorative or informative purposes. With regulatory requirements requiring more information on product labelling and the marketers desire to provide increasing decorative elements to packaging there is a desire to use more of the container surface area for labelling. The packaging industry has considered the use of shrink labelling to enable a greater label coverage of the container's surface.

However, the use of shrink-labelling with containers having handles poses a problem in that in the case of a container having a handle on its side where the shrink labelling would cover, the use of a shrink sleeve, as is conventionally used in shrink wrapping, would cover up the through portion of the handle obstructing the user's gripping of the handle.

U.S. Pat. No. 6,730,253 discloses a decorative sleeve shrunk around the outside of a container. The sleeve has a cut-out region around the container handle allowing the shrink label to be fitted on a container having a handle. However, the present inventors have found that this can leave unsightly edges and rough edges detracting from the visual appearance and comfort during use.

Accordingly, for containers having a handle on its side and wherein it is desired to provide greater surface area for decorative or informative labelling, there exists a need for a container having a shrink label that can be applied in a fashion to prevent any unsightly edges or rough edges.

An object of the present invention is to provide a container with a side handle having a shrink label that is not susceptible to unsightly edges or rough edges.

### SUMMARY OF THE INVENTION

The present invention is directed to a container having a base, a top part and sides, the container being shrink labelled and the container having a handle that is attached to the container after the container is shrink labelled.

The present invention is directed to a process for the manufacture of a container, the container having a base, a top part, sides, and a handle, and having a shrink sleeve around the outside of the container, wherein the process comprises the steps of:

a) forming a container having a base, a top part and sides;

b) shrink labelling the container in a shrink sleeve; and

c) attaching a handle to the container after the container is shrink labelled with the shrink sleeve.

All numerical ranges and percentages in this specification and claims are intended to be modified by the term about.

As used herein, the term “comprising” means that a specified material or element is present, optionally together a further material or element, and includes including, made up of, composed of, consisting and/or consisting essentially of.

For a more complete understanding of the above and other features and advantages of the invention, reference should be made to the following detailed description of preferred embodiments and to the accompanying drawing.

### BRIEF DESCRIPTION OF THE DRAWINGS

FIG. 1 is a perspective view of a container according to the invention before a shrink label or handle has been applied.

FIG. 2 is a perspective view of a container according to the invention after a shrink label has been applied but before a handle has been attached.

FIG. 3 is a perspective view of a container according to the invention with a shrink label applied and a handle attached.

### DETAILED DESCRIPTION OF THE INVENTION

The invention relates to a container which is shrink labelled. The term container hereby should be understood generally to include any type of packaging for holding products, such as a container for fluid products, fluid products.

The container 2 has a base 4. By a base it should be understood a part of the container on which the container is left to stand upright. The base should have a surface suitable to hold the container in a stable position on a flat supporting surface. For example, the base may be flat, or may be formed from a molded tripod, or from a flat ring.

The container also comprises sides 8. The sides are the surfaces which generally speaking are joining the top and the base of the container. Typically, when the container is upright, the sides are substantially vertical and perpendicular to the base. In some containers, the sides have an exit for the content of the container.

The container further comprises a top part 6. The top part is typically the part of the container opposed to the base. The top is commonly the part of the container which provides an exit for the content of the container.

The container can be made of any material desired that is compatible with the shrink label. Preferably, the container is made of polyester, otherwise known as polyethylene terephthalate (PET), polypropylene (PP) or high density polyethylene (HDPE).

The container is shrink-labelled. Shrink labelling consists of enveloping a part of the container in a thermoplastic tube like sleeve, the sleeve being heated to shrink and fit snug onto the container.

The shrink sleeve 12 may be comprised of any material known for such purposes. Typical thermoplastic materials used for film shrink sleeving include polyvinylchloride (PVC), low or high density polyethylene (LDPE, HDPE), polyethylene terephthalate (PET), polypropylene (PP) and oriented polypropylene (OPP), polystyrene (PS) and oriented polystyrene (OPS), and mixtures thereof.

Preferably the sleeve covers at least 30% of the outer surface of the container, in order to provide for a sufficient surface for indicia such as product information and container decoration. More preferably, the sleeve covers at least 50% of the outer surface of the container, even more preferably 65%, and most preferably at least 80% of the outer surface of the container. It should be understood the “outer surface of the container” hereby comprises the whole outer surface, including the outer surface of the base.

The container comprises a handle 10. Preferably the handle 10 is located on a side of the container. The handle is applied to the container after the container is shrink labelled. This allows the shrink label to cover the container surface with minimal exposed edges thereby improving appearance and comfort to the user. The handle forms a recess such that a user may slide the hand in the recess to hold the container by the handle.

The handle can be applied to the container in any manner desired. In a preferred method, the container has two depressions in the container sidewall to receive and lock in the handle ends.

In another embodiment, the handle could have an upper ring that goes over the container's neck finish and also a lower piece that snaps into a lower depression in the container. Alternatively, the handle's lower piece could clip onto a knob on the lower portion of the bottle, or the handle's lower piece could form a base for secure attachment and to support the weight of the bottle.

In another embodiment, the container could have a knob on the side of the container's neck finish where a “clip” on the handle could snap onto and be attached. In this embodiment the handle could have a clip on the lower portion that connects to the lower portion of the container.

In another embodiment, the top of the handle could, clip around the cylindrical neck finish of the bottle and the lower portion of the handle could clip around a lower portion of the bottle.

With all of the separate handle attachment means, hot-melt adhesive could also be used to assist in making a more secure connection and attachment to the bottle. Alternatively, a combination of piercing and spin-welding could be used to attach either the upper or lower portions of the plastic handle to the plastic bottle.

In another embodiment, without piercing the label film, spin welding could melt the interface of the upper or lower portion of the handle, the label film and the bottle surface to form a secure bond between handle and bottle after the molten plastics cooled.

It should be understood that in the above mentioned embodiments as well as other embodiments within the scope of this invention, either the handle itself could pierce the shrink label area over depression(s) or clips or whatever means are used to attached the handle to the container. Similarly, the shrink label could be mechanically pierced prior to snapping in the handle. Preferably, the end(s) of the handle would be appropriately shaped for film label piercing, such as having a semi-pointy tip with an “X” shape design. This would cut and fold the shrink label over the hole(s) into neat quadrants.

The plastic handle could be injection molded of virgin resin such as PP, or it could be made of 100% recycled PP or PET resin. The container could be made of PET, PP, PVC or HDPE. In a preferred embodiment, the handle is made entirely of post-consumer recycled resin (PCR).

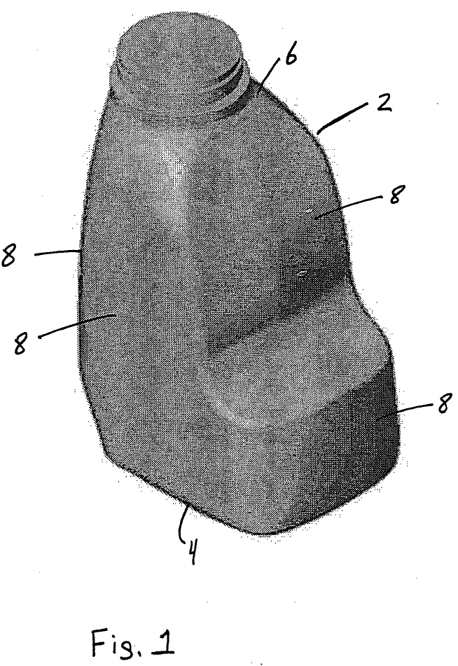

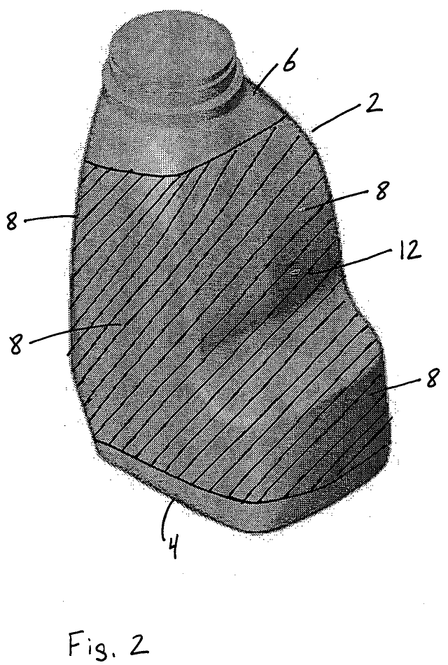

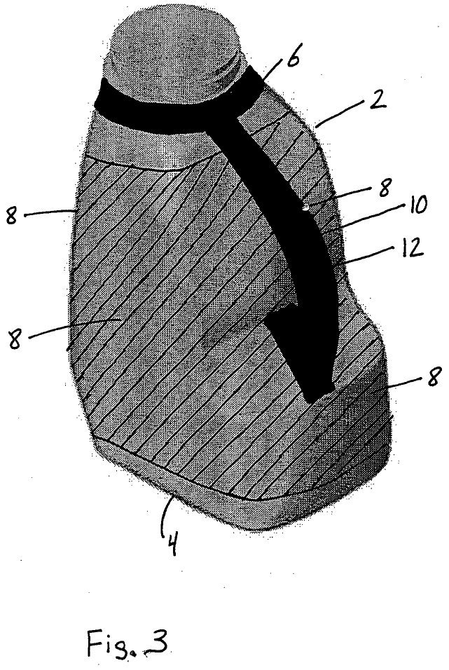

The present invention is also direct at a process for the manufacture of a container, the container having a base, a top part, sides, and a handle, and having a shrink sleeve around the outside of the container, wherein the process comprises the steps of: forming a container having a base, a top part and sides; shrink labelling the container in a shrink sleeve; and attaching a handle to the container after the container is shrink labelled with the shrink sleeve. These steps are shown in FIGS. 1-3. In FIG. 1, a container according to the invention is shown before a shrink label or handle has been applied. In FIG. 2, a container according to the invention is shown after a shrink label has been applied but before a handle has been attached. In FIG. 3, a container according to the invention is shown with a shrink label applied and a handle attached.

It should be understood of course that the specific forms of the invention herein illustrated and described are intended to be representative only as certain changes may be made therein without departing from the clear teachings of the disclosure. Accordingly, reference should be made to the following appended claims in determining the full scope of the invention.

What is claimed is:

1. A container having a base, a top part and sides, the container being shrink labelled and the container having a handle that is attached to the container after the container is shrink labelled.

2. A container according to claim 1 wherein the shrink label covers at least 30% of the outer surface of the container.

3. A container according to claim 1 wherein the shrink label covers at least 50% of the outer surface of the container.

4. A container according to claim 1 wherein the shrink label covers at least 65% of the outer surface of the container.

5. A container according to claim 1 wherein the shrink label covers at least 80% of the outer surface of the container.

6. A process for the manufacture of a container, the container having a base, a top part, sides, and a handle, and having a shrink sleeve around the outside of the container, wherein the process comprises the steps of:
a) forming a container having a base, a top part and sides;
b) shrink labelling the container in a shrink sleeve;
c) attaching a handle to the container after the container is shrink labelled with the shrink sleeve.
